(19) United States
(12) Patent Application Publication
(10) Pub. No.: US 2025/0164832 A1
(43) Pub. Date: May 22, 2025

(54) DISPLAY PANEL HAVING SWITCHABLE WIDE AND NARROW VIEWING ANGLES AND DRIVING METHOD, AND DISPLAY DEVICE

(71) Applicant: INFOVISION OPTOELECTRONICS (KUNSHAN) CO., LTD., Suzhou City, Jiangsu Province (CN)

(72) Inventors: CHIA-TE LIAO, Suzhou City, Jiangsu Province (CN); CHIAMIN YU, Suzhou City, Jiangsu Province (CN); LIMEI JIANG, Suzhou City, Jiangsu Province (CN)

(21) Appl. No.: 18/715,115

(22) PCT Filed: Aug. 8, 2022
(86) PCT No.: PCT/CN2022/110986

§ 371 Date: Jan. 22, 2025

(51) Int. Cl. G02F 1/13; G02F 1/133; G02F 1/1343

(52) U.S. Cl. CPC G02F 1/1323; G02F 1/13306; G02F 1/134309

(57) ABSTRACT

Disclosed are a display panel having switchable wide and narrow viewing angles and a driving method, and a display device. The display panel has a first graphic region and a second graphic region that are patterned; the display panel comprises a light adjusting box and a display box stacked on each other; the light adjusting box comprises a first substrate, a second substrate, and a first liquid crystal layer; the first substrate is provided with a common viewing angle electrode; the second substrate is provided with a first viewing angle electrode and a second viewing angle electrode working in conjunction with the common viewing angle electrode; the first viewing angle electrode corresponds to the first graphic region; the second viewing angle electrode corresponds to the second graphic region.

### TECHNICAL FIELD

The present application relates to the technical field of display technology, and in particular, to a display panel having switchable wide and narrow viewing angles and a driving method, and a display device.

### BACKGROUND OF RELATED ART

With the continuous progress of LCD technology, the viewing angle of the display device has been widened from about 112° to more than 160°. While people enjoy the visual experience brought by wide viewing angle, they also hope to effectively protect business secrets and personal privacy, so as to avoid the commercial loss or embarrassment caused by the leakage of screen information. Therefore, in addition to the requirement of wide viewing angle, the display device is also required to have the function of switching between wide and narrow viewing angles in many occasions.

At present, the main way to switch between wide and narrow viewing angles is to attach a louver shielding film onto the display screen. When it is necessary to prevent peeping, the louver shielding film can be used to cover the screen to reduce the viewing angle. However, this method requires additional preparation of the louver shielding film, which will cause great inconvenience to users, and a louver shielding film can only achieve one viewing angle. Once the louver shielding film is attached, the viewing angle will be fixed in the narrow viewing angle mode. As a result, it is impossible to switch freely between the wide viewing angle mode and the narrow viewing angle mode, and the louver shielding film will reduce the brightness and the display effect.

### BRIEF SUMMARY OF THE APPLICATION

### Technical Problem

The existing technology also uses a light adjusting box in combination with a display panel to switch between a wide viewing angle and a narrow viewing angle. The display panel is used for normal picture display. The light adjusting box is used to control the viewing angle switching. The light adjusting box includes a first substrate, a second substrate, and a liquid crystal layer arranged between the first substrate and the second substrate. The viewing angle control electrodes provided on the first substrate and the second substrate generate a vertical electric field on the liquid crystal molecules, so that the liquid crystal molecules deflect in a vertical direction, thereby realizing the narrow viewing angle. By controlling the voltages applied to the viewing angle control electrodes, it is thus possible to switch between a wide viewing angle mode and a narrow viewing angle mode. However, when the display panel having switchable wide and narrow viewing angles is in the narrow viewing angle mode, there may be a grayscale reversal problem when seeing from large viewing angle (from −55° to −75° and from 55° to) 75°. Although the color of the displayed picture cannot be clearly seen from large viewing angle, the displayed picture can still be roughly seen, resulting in poor anti-peeping effect in the narrow viewing angle mode.

### Technical Solution

In order to overcome the shortcomings and deficiencies in the existing technology, the object of the present application is to provide a display panel having switchable wide and narrow viewing angles and a driving method, and a display device, so as to solve the problem of poor anti-peeping effect at large viewing angle when the display panel is in the narrow viewing angle mode in the existing technology.

The object of the present application is realized through the following technical solutions:

The present application provides a driving method for a display panel having switchable wide and narrow viewing angles, wherein the display panel has a first graphic region and a second graphic region, and the display panel includes a light adjusting box and a display box which are stacked with one on another;
the light adjusting box includes a first substrate, a second substrate opposite to the first substrate, and a first liquid crystal layer between the first substrate and the second substrate, the first substrate is provided with a common viewing angle electrode on the side facing the first liquid crystal layer, the second substrate is provided with a first viewing angle electrode and a second viewing angle electrode which are cooperated with the common viewing angle electrode on the side facing the first liquid crystal layer, the first viewing angle electrode and the second viewing angle electrode are insulated and separated from each other, the first viewing angle electrode corresponds to the first graphic region, the second viewing angle electrode corresponds to the second graphic region;
the driving method includes:
in the wide viewing angle mode, a first electrical signal is applied to the common viewing angle electrode, and a second electrical signal is applied to both the first viewing angle electrode and the second viewing angle electrode, the voltage difference between the second electrical signal and the first electrical signal is less than a first preset value or greater than a second preset value, the transmittance of the first graphic region and the second graphic region is the same from the same side viewing angle;
in the narrow viewing angle mode, a first electrical signal is applied to the common viewing angle electrode, a third electrical signal is applied to the first viewing angle electrode, and a fourth electrical signal is applied to the second viewing angle electrode, the voltage difference between the third electrical signal and the first electrical signal, as well as the voltage difference between the fourth electrical signal and the first electrical signal, are both greater than a third preset value and less than a fourth preset value, wherein the amplitude of the third electrical signal is different from the amplitude of the fourth electrical signal for at least part of the time within one period, and the amplitude of the third electrical signal periodically changes, such that the transmittance of the first graphic region from the same side viewing angle periodically changes;
wherein the first preset value is less than or equal to the third preset value, and the second preset value is greater than the fourth preset value.

Further, the amplitude of the third electrical signal is different from the amplitude of the fourth electrical signal all the time within the period, and the amplitude of the fourth electrical signal periodically changes.

Further, both the first electrical signal and the second electrical signal are 0V DC voltage; or the first electrical signal is 0V DC voltage, and the second electrical signal is an AC voltage with an amplitude greater than 5V.

Further, the amplitudes of the third electrical signal and the fourth electrical signal are each 1.6V-2.4V, and both the third electrical signal and the fourth electrical signal are AC voltage.

Further, when the amplitude of the third electrical signal is different from the amplitude of the fourth electrical signal, the amplitude difference between the third electrical signal and the fourth electrical signal is 0.2V-0.6V.

Further, the polarity of the third electrical signal is the same as the polarity of the fourth electrical signal at the same time.

Further, the display panel has a third graphic region, the second substrate is provided with a third viewing angle electrode cooperating with the common viewing angle electrode on the side facing the first liquid crystal layer, the third viewing angle electrode corresponds to the third graphic region, and the first viewing angle electrode, the second viewing angle electrode and the third viewing angle electrode are mutually insulated from each other;
the driving method further includes:
in the wide viewing angle mode, the second electrical signal is applied to the third viewing angle electrode;
in the narrow viewing angle mode, a fifth electrical signal is applied to the third viewing angle electrode, the voltage difference between the fifth electrical signal and the first electrical signal is greater than the third preset value and less than the fourth preset value, wherein the amplitude of the fifth electrical signal is different from the amplitude of the third electrical signal all the time within the period, and the amplitude of the fifth electrical signal periodically changes.

Further, the fifth electrical signal is an AC voltage with an amplitude between 1.6V-2.4V, when the amplitude of the fifth electrical signal is different from the amplitude of the third electrical signal, the amplitude difference between the fifth electrical signal and the fourth electrical signal is 0.2V-0.6V.

The present application further provides a display panel having switchable wide and narrow viewing angles, wherein the display panel is driven using the driving method described above, the display panel has a first graphic region and a second graphic region, and the display panel includes a light adjusting box and a display box which are stacked with one on another;

the light adjusting box includes a first substrate, a second substrate opposite to the first substrate, and a first liquid crystal layer between the first substrate and the second substrate, the first substrate is provided with a common viewing angle electrode on the side facing the first liquid crystal layer, the second substrate is provided with a first viewing angle electrode and a second viewing angle electrode which are cooperated with the common viewing angle electrode on the side facing the first liquid crystal layer, the first viewing angle electrode and the second viewing angle electrode are insulated and separated from each other, the first viewing angle electrode corresponds to the first graphic region, the second viewing angle electrode corresponds to the second graphic region.

Further, both the first graphic region and the first viewing angle electrode are multiple block structures arranged along the row/column direction and spaced from each other, the second graphic region surrounds the periphery of the first graphic region, and the second viewing angle electrode surrounds the periphery of the first viewing angle electrode.

Further, both the first graphic region and the first viewing angle electrode have multiple rows/columns.

Further, the first graphic region, the second graphic region, the first viewing angle electrode and the second viewing angle electrode are all block structures, wherein the first graphic region and the second graphic region are arranged alternately in both row and column directions, and the first viewing angle electrode and the second viewing angle electrode are arranged alternately in both row and column directions.

Further, the display panel has a third graphic region, the second substrate is provided with a third viewing angle electrode cooperating with the common viewing angle electrode on the side facing the first liquid crystal layer, the third viewing angle electrode corresponds to the third graphic region, and the first viewing angle electrode, the second viewing angle electrode and the third viewing angle electrode are mutually insulated from each other.

Further, the first graphic region, the third graphic region, the first viewing angle electrode and the third viewing angle electrode are all block structures, wherein the first graphic region and the third graphic region are arranged alternately along the row/column direction, the second graphic region surrounds the periphery of the first graphic region and the third graphic region, the first viewing angle electrode and the third viewing angle electrode are arranged alternately along the row/column direction, and the second viewing angle electrode surrounds the periphery of the first viewing angle electrode and the third viewing angle electrode.

Further, the first graphic region and the third graphic region are arranged alternately in both row and column directions, and the first viewing angle electrode and the third viewing angle electrode are arranged alternately in both row and column directions.

Further, the second substrate is provided with an electrode network on the side facing the first liquid crystal layer, the electrode network includes a first electrode network and a second electrode network which are mutually insulated and separated from each other, the first viewing angle electrode is electrically connected to the first electrode network, and the second viewing angle electrode is electrically connected to the second electrode network.

The present application further provides a display device including the display panel described above.

### Beneficial Effects

The display panel has a first graphic region and a second graphic region that are patterned, and the display panel includes a light adjusting box and a display box which are stacked with one on another. The light adjusting box includes a first substrate, a second substrate, and a first liquid crystal layer. The first substrate is provided with a common viewing angle electrode, and the second substrate is provided with a first viewing angle electrode and a second viewing angle electrode that are cooperated with the common viewing angle electrode. The first viewing angle electrode corresponds to the first graphic region, and the second viewing angle electrode corresponds to the second graphic region. In the narrow viewing angle mode, a first electrical signal is applied to the common viewing angle electrode, a third electrical signal is applied to the first viewing angle electrode, and a fourth electrical signal is applied to the second viewing angle electrode. The amplitude of the third electrical signal is different from the amplitude of the fourth electrical signal for at least part of the time within one period, and the amplitude of the third electrical signal periodically changes, such that the transmittance of the first graphic region from the same side viewing angle also periodically changes. That is, when seeing from large viewing angle, the brightness of the first graphic region will flicker, thereby affecting seeing the displayed picture from large viewing angle. Thus, even in the case of grayscale reversal, the displayed picture on the display panel cannot be seen, thereby increasing the anti-peeping effect at large viewing angle.

### BRIEF DESCRIPTION OF THE DRAWINGS

FIG. 1 is a first schematic diagram of the structure of the display panel in the wide viewing angle mode according to the first embodiment of the present application.

FIG. 2 is a second schematic diagram of the structure of the display panel in the wide viewing angle mode according to the first embodiment of the present application.

FIG. 3 is a schematic diagram of the structure of the display panel in the narrow viewing angle mode according to the first embodiment of the present application.

FIG. 4 is a schematic diagram of the planar structure of the display panel in the first embodiment of the present application.

FIG. 5 is a schematic diagram of the planar structures of the first viewing angle electrode and the second viewing angle electrode in the first embodiment of the present application.

FIG. 6 is a schematic diagram of the planar structure of the electrode network in the first embodiment of the present application.

FIG. 7 is a diagram of the signal waveform of the display panel in the wide viewing angle mode according to the first embodiment of the present application.

FIG. 8 is a diagram of the signal waveform of the display panel in the narrow viewing angle mode according to the first embodiment of the present application.

FIG. 9 is a simulation diagram of the transmittance of the display panel in the wide viewing angle mode according to the first embodiment of the present application.

FIG. 10 is a simulation diagram of the transmittance of the display panel in the narrow viewing angle mode according to the first embodiment of the present application.

FIG. 11 is a first schematic diagram of the structure of the display panel in the narrow viewing angle mode in another embodiment of the present application.

FIG. 12 is a second schematic diagram of the structure of the display panel in the narrow viewing angle mode in another embodiment of the present application.

FIG. 13 is a third schematic diagram of the structure of the display panel in the narrow viewing angle mode in another embodiment of the present application.

FIG. 14 is a diagram of the signal waveform of the display panel in the second embodiment of the present application in the narrow viewing angle mode.

FIG. 15 is a schematic diagram of the planar structure of the display panel in the third embodiment of the present application.

FIG. 16 is a schematic diagram of the planar structure of the first viewing angle electrode, the second viewing angle electrode and the third viewing angle electrode in the third embodiment of the present application.

FIG. 17 is a diagram of the signal waveform of the display panel in the third embodiment of the present application in the narrow viewing angle mode.

FIG. 18 is a schematic diagram of the planar structure of the display panel in the fourth embodiment of the present application.

FIG. 19 is a schematic diagram of the planar structure of the first viewing angle electrode and the second viewing angle electrode in the fourth embodiment of the present application.

FIG. 20 is a schematic diagram of the planar structure of the display panel in the fifth embodiment of the present application.

FIG. 21 is a schematic diagram of the planar structure of the first viewing angle electrode and the second viewing angle electrode in the fifth embodiment of the present application.

FIG. 22 is a first schematic diagram of the planar structure of the display device in the present application.

FIG. 23 is a second schematic diagram of the planar structure of the display device in the present application.

### DETAILED DESCRIPTION OF THE EMBODIMENTS

In order to further illustrate the technical solutions and effects of the present application to achieve its intended purpose, the following describes the specific implementation mode, structures, features and effects of the display panel having switchable wide and narrow viewing angles, the driving method and the display device provided by the present application in combination with the drawings and preferred embodiments as follows.

### First Embodiment

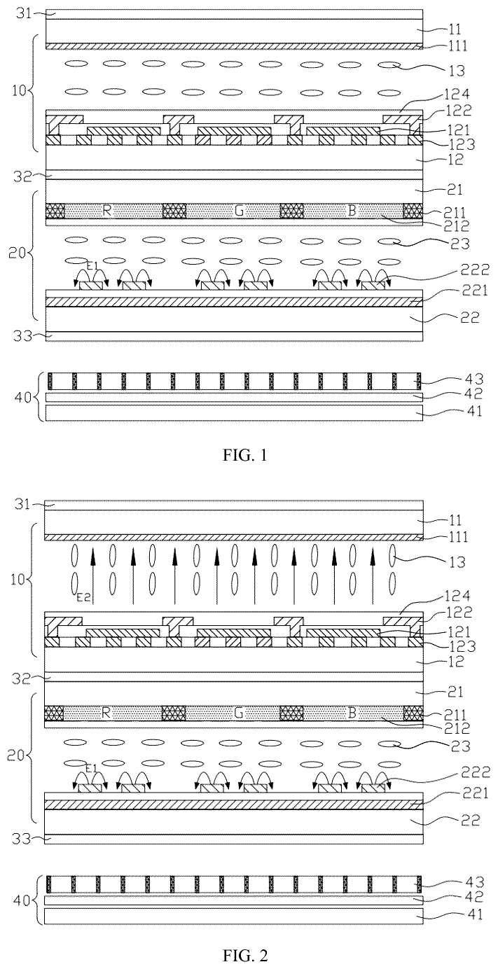

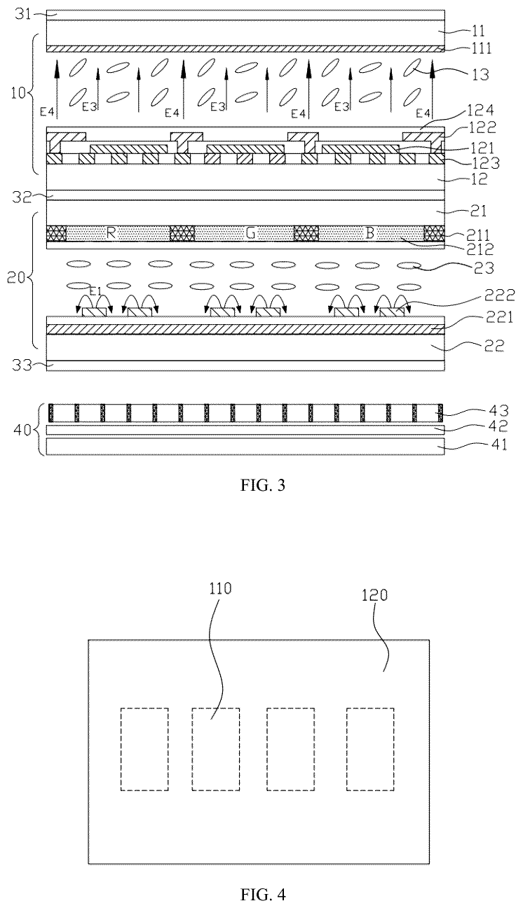

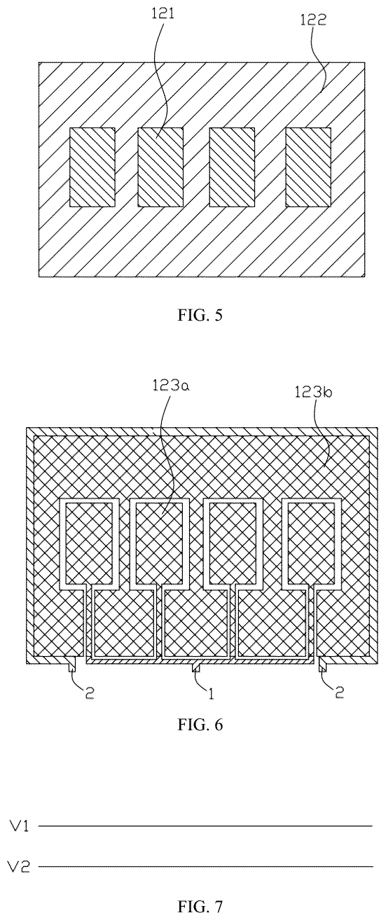

FIG. 1 is a first schematic diagram of the structure of the display panel in the wide viewing angle mode according to the first embodiment of the present application. FIG. 2 is a second schematic diagram of the structure of the display panel in the wide viewing angle mode according to the first embodiment of the present application. FIG. 3 is a schematic diagram of the structure of the display panel in the narrow viewing angle mode according to the first embodiment of the present application. FIG. 4 is a schematic diagram of the planar structure of the display panel in the first embodiment of the present application. FIG. 5 is a schematic diagram of the planar structures of the first viewing angle electrode and the second viewing angle electrode in the first embodiment of the present application. FIG. 6 is a schematic diagram of the planar structure of the electrode network in the first embodiment of the present application. As shown in FIGS. 1 to 6, the first embodiment of the present application provides a display panel having switchable wide and narrow viewing angles. The display panel has a first graphic region 110 and a second graphic region 120 (FIG. 4). The display panel includes a light adjusting box 10 and a display box 20 which are stacked with one on another. In this embodiment, the light adjusting box 10 is arranged above the display box 20, that is, the light adjusting box 10 is located on the light exit side of the display box 20. The light adjusting box 10 is used to control the viewing angle of the display panel, and the display box 20 is used to control the display of normal picture on the display panel. Optionally, the light adjusting box 10 can also be arranged below the display box 20, that is, the light adjusting box 10 is located on the light incident side of the display box 20.

The light adjusting box 10 includes a first substrate 11, a second substrate 12 arranged opposite to the first substrate 11, and a first liquid crystal layer 13 arranged between the first substrate 11 and the second substrate 12. The first substrate 11 is provided with a common viewing angle electrode 111 on the side facing the first liquid crystal layer 13. The second substrate 12 is provided with a first viewing angle electrode 121 and a second viewing angle electrode 122 which are cooperated with the common viewing angle electrode 111 on the side facing the first liquid crystal layer 13. The first viewing angle electrode 121 and the second viewing angle electrode 122 are insulated and separated from each other. The first viewing angle electrode 121 corresponds to the first graphic region 110, and the second viewing angle electrode 122 corresponds to the second graphic region 120. By controlling the voltage differences between the common viewing angle electrode 111 and the first viewing angle electrode 121, as well as between the common viewing angle electrode 111 and the second viewing angle electrode 122, the deflection of liquid crystal molecules in the first liquid crystal layer 13 is controlled, thereby achieving the switching between wide and narrow viewing angles.

The first liquid crystal layer 13 preferably adopts positive liquid crystal molecules, i.e., liquid crystal molecules with positive dielectric anisotropy. The phase delay of the first liquid crystal layer 13 is preferably 700 nm, and the optional range is 500 nm<phase delay<1000 nm. In the initial state, the positive liquid crystal molecules in the first liquid crystal layer 13 are aligned parallel to the first substrate 11 and the second substrate 12, and the alignment direction of the positive liquid crystal molecules on the side near the first substrate 11 is parallel or reverse to the alignment direction of the positive liquid crystal molecules on the side near the second substrate 12, thereby resulting in a wide viewing angle display of the light adjusting box 10 in the initial state, as shown in FIG. 1. When it is necessary to achieve narrow viewing angle display, control voltages are respectively applied to the common viewing angle electrode 111, the first viewing angle electrode 121 and the second viewing angle electrode 122, resulting in a large voltage difference and a strong electric field between the common viewing angle electrode 111 and the first viewing angle electrode 121, as well as between the common viewing angle electrode 111 and the second viewing angle electrode 122, so as to drive the positive liquid crystal molecules in the first liquid crystal layer 13 to deflect in the vertical direction, thereby resulting in a narrow viewing angle display of the light adjusting box 10, as shown in FIG. 3.

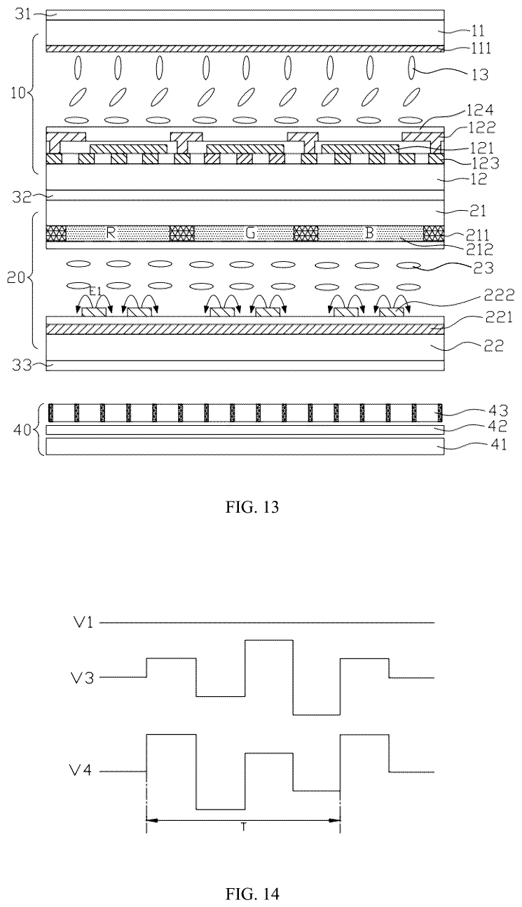

In one embodiment, as shown in FIG. 12, the first liquid crystal layer 13 can also adopt negative liquid crystal molecules, i.e., liquid crystal molecules with negative dielectric anisotropy. In the initial state, the positive liquid crystal molecules in the first liquid crystal layer 13 are aligned perpendicular to the first substrate 11 and the second substrate 12. Alternatively, as shown in FIG. 13, when the first liquid crystal layer 13 adopts positive liquid crystal molecules, the positive liquid crystal molecules on the side near the second substrate 12 are aligned parallel to the second substrate 12, while the positive liquid crystal molecules on the side near the first substrate 11 are aligned perpendicular to the first substrate 11, that is, the positive liquid crystal molecules in the first liquid crystal layer 13 adopt mixed alignment. Optionally, it can also be that the positive liquid crystal molecules on the side near the second substrate 12 are aligned perpendicular to the second substrate 12, while the positive liquid crystal molecules on the side near the first substrate 11 are aligned parallel to the first substrate 11.

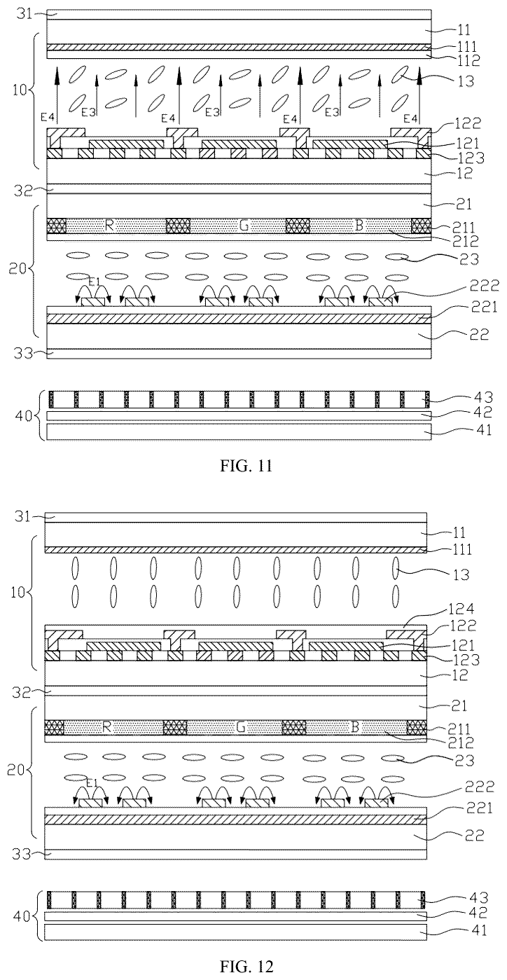

In this embodiment, the second substrate 12 is provided with an insulation layer 124 on the side facing the first liquid crystal layer 13, and the insulation layer 124 is located on the side of the second substrate 12 closest to the first liquid crystal layer 13. The insulation layer 124 covers the second viewing angle electrode 122, thereby avoiding a short circuit between the common viewing angle electrode 111 and the second viewing angle electrode 122. Optionally, in one embodiment, as shown in FIG. 11, it is also possible to have an overcoat layer 112 on the side of the first substrate 11 facing the first liquid crystal layer 13, and the overcoat layer 112 covers the common viewing angle electrode 111, thereby avoiding a short circuit between the common viewing angle electrode 111 and the second viewing angle electrode 122. Alternatively, the second substrate 12 is provided with an insulation layer 124 on the side facing the first liquid crystal layer 13, and the first substrate 11 is provided with an overcoat layer 112 on the side facing the first liquid crystal layer 13.

In this embodiment, the second viewing angle electrode 122 and the first viewing angle electrode 121 are located in different layers, and the second viewing angle electrode 122 and the first viewing angle electrode 121 are separated by an insulation layer, thereby avoiding the risk of short circuit between the second viewing angle electrode 122 and the first viewing angle electrode 121. Optionally, in other embodiments, the second viewing angle electrode 122 and the first viewing angle electrode 121 can also be located on the same layer to avoid the difference in reflectivity between the second viewing angle electrode 122 and the first viewing angle electrode 121, which may result in difference in brightness between the first graphic region 110 and the second graphic region 120 from front viewing angle under the wide or narrow viewing angle mode and affect the normal display of the picture.

As shown in FIGS. 4 and 5, both the first graphic region 110 and the first viewing angle electrode 121 are multiple block structures arranged along the row direction and spaced from each other. The second graphic region 120 surrounds the periphery of the first graphic region 110, and the second viewing angle electrode 122 surrounds the periphery of the first viewing angle electrode 121. Optionally, in other embodiments, both the first graphic region 110 and the first viewing angle electrode 121 can also be multiple block structures arranged along the column direction and spaced from each other. Specifically, the shape of each block structure of the first graphic region 110 and the first viewing angle electrode 121 can be a square block, a circular block, an icon pattern, or other shapes. For example, when seeing an icon pattern from large viewing angle in the narrow viewing angle mode, it can be seen that the brightness of the icon pattern is changing.

Furthermore, the second substrate 12 is provided with an electrode network 123 on the side facing the first liquid crystal layer 13. The electrode network 123 includes a first electrode network 123a and a second electrode network 123b which are insulated and separated from each other. The first viewing angle electrode 121 is electrically connected to the first electrode network 123a, and the second viewing angle electrode 122 is electrically connected to the second electrode network 123b. In this embodiment, the first electrode network 123a and the second electrode network 123b are located on the same layer. The first viewing angle electrode 121 is arranged on the upper surface of the first electrode network 123a and in electrical contact with the first electrode network 123a, thereby reducing the resistance of the first viewing angle electrode 121. The second viewing angle electrode 122 is electrically connected to the second electrode network 123b through contact hole, thereby reducing the resistance of the second viewing angle electrode 122.

In the non-display edge area, the light adjusting box 10 is provided with a first signal line 1 electrically connected to the first electrode network 123a and a second signal line 2 electrically connected to the second electrode network 123b. The first signal line 1 and the second signal line 2 are both led out around the edge area of the light adjusting box 10, such that a voltage signal can be applied to the first viewing angle electrode 121 through the first signal line 1, and a voltage signal can be applied to the second viewing angle electrode 122 through the second signal line 2.

In this embodiment, the display box 20 is preferably a liquid crystal box. Optionally, in other embodiments, the display box 20 can also be a self-illuminated display device (for example, OLED display device, or micro LED display device), but the light adjusting box 10 needs to be set above the display box 20.

The display box 20 includes a color film substrate 21, an array substrate 22 arranged opposite to the color film substrate 21, and a second liquid crystal layer 23 arranged between the color film substrate 21 and the array substrate 22. The second liquid crystal layer 23 preferably adopts positive liquid crystal molecules, i.e., liquid crystal molecules with positive dielectric anisotropy. In the initial state, the positive liquid crystal molecules in the second liquid crystal layer 23 are aligned parallel to the color film substrate 21 and the array substrate 22, and the alignment direction of the positive liquid crystal molecules on the side near the color film substrate 21 is parallel or reverse to the alignment direction of the positive liquid crystal molecules on the side near the array substrate 22. Optionally, in other embodiments, the second liquid crystal layer 23 can also adopt negative liquid crystal molecules, and the negative liquid crystal molecules in the second liquid crystal layer 23 can be aligned perpendicular to the color film substrate 21 and the array substrate 22, which is similar to the alignment direction of the VA display mode.

Furthermore, a first polarizer 31 is provided on the side of the light adjusting box 10 away from the display box 20, a second polarizer 32 is provided between the light adjusting box 10 and the display box 20, and a third polarizer 33 is provided on the side of the display box 20 away from the light adjusting box 10, wherein the transmission axis of the first polarizer 31 is parallel to the transmission axis of the second polarizer 32, and the transmission axis of the third polarizer 33 is perpendicular to the transmission axis of the second polarizer 32.

Specifically, the alignment direction of the first liquid crystal layer 13 can be perpendicular to the transmission axis of the first polarizer 31 and the second polarizer 32, for example, the transmission axis of the first polarizer 31 and the second polarizer 32 is 0°, and the alignment direction of the first liquid crystal layer 13 is 90°. Optionally, the alignment direction of the first liquid crystal layer 13 can also be parallel to the transmission axis of the first polarizer 31 and the second polarizer 32, for example, the transmission axis of the first polarizer 31 and the second polarizer 32 is 90°, and the alignment direction of the first liquid crystal layer 13 is 90°.

The color film substrate 21 is provided with an array of color resists 212 and a black matrix 211 that separates the color resists 212. The color resists 212 include red (R), green (G), and blue (B) color resist materials, so as to form sub pixels of three colors, i.e., red (R), green (G), and blue (B) correspondingly. Specifically, each block structure of the first graphic region 110 can correspond to multiple sub pixels or only one sub pixel.

On the side facing the second liquid crystal layer 23, the array substrate 22 is provided with a plurality of scanning lines (not shown) and a plurality of data lines (not shown), which are insulated and intersected to form a plurality of pixel units. A pixel electrode 222 and a thin film transistor (not shown) are provided in each pixel unit, and through the thin film transistor, the pixel electrode 222 is electrically connected to the data line adjacent to the thin film transistor. The thin film transistor includes a gate, an active layer, a drain and a source. The gate and the scanning line are located on the same layer and electrically connected. The gate and the active layer are separated by an insulating layer. The source and the data line are electrically connected. The drain and the pixel electrode 222 are electrically connected through a contact hole.

As shown in FIG. 1, in this embodiment, the array substrate 22 is further provided with a common electrode 221 on the side facing the second liquid crystal layer 23. The common electrode 221 and the pixel electrode 222 are located in different layers, and are insulated by an insulation layer. The common electrode 221 can be located above or below the pixel electrode 222 (as shown in FIG. 1, the common electrode 221 is located below the pixel electrode 222). Preferably, the common electrode 221 is a planar electrode arranged on the whole surface of the array substrate 22, and the pixel electrode 222 arranged in each pixel unit is a whole block electrode or a slit electrode with multiple electrode strips, so as to form a fringe field switching (FFS) mode. Optionally, in other embodiments, the pixel electrode 222 and the common electrode 221 can be located on the same layer, but they are insulated and separated from each other, each of the pixel electrode 222 and the common electrode 221 can include multiple electrode strips, and the electrode strips of the pixel electrode 222 are arranged alternately with the electrode strips of the common electrode 221, so as to form an in-plane switching (IPS) mode. Alternatively, in other embodiments, the array substrate 22 is provided with pixel electrodes 222 on the side facing the second liquid crystal layer 23, and the color film substrate 21 is provided with a common electrode 221 on the side facing the second liquid crystal layer 23, so as to form a TN mode or a VA mode.

Specifically, the first substrate 11, the second substrate 12, the color film substrate 21 and the array substrate 22 can be made of materials such as glass, acrylic acid, and polycarbonate. The materials for the common viewing angle electrode 111, the first viewing angle electrode 121, the second viewing angle electrode 122, the common electrode 221 and the pixel electrodes 222 can be indium tin oxide (ITO) or indium zinc oxide (IZO).

The present application further provides a display device, including the display panel having switchable wide and narrow viewing angles as described above, and a backlight module 40. The backlight module 40 is located below the display panel to provide a backlight source for the display panel. Optionally, if the display box 20 adopts a self-illuminated display, then the display device does not need to set an additional backlight source.

The backlight module 40 includes a backlight source 41 and an anti-peeping layer 43. The anti-peeping layer 43 is used to narrow the range of light emission angle. A brightening film 42 is further provided between the backlight source 41 and the anti-peeping layer 43, and the brightening film 42 increases the brightness of the backlight module 40. Specifically, the anti-peeping layer 43 is equivalent to a miniature louver structure which can block lights with larger incidence angles, allowing lights with smaller incidence angles to pass through, such that the angle range of lights passing through the anti-peeping layer 43 is reduced. The anti-peeping layer 43 includes a plurality of parallel light blocking walls and light penetrating holes located between adjacent light blocking walls, with a light absorbing material on both sides of the light blocking walls. Optionally, the backlight source 41 can also use a concentrated backlight, thus eliminating the need for the anti-peeping layer 43, but the concentrated backlight source is more expensive than the conventional backlight sources.

The backlight module 40 may be an edge-type backlight module or a direct-type backlight module. Preferably, the backlight module 40 adopts the collimated backlight (CBL) mode, which can collect lights and ensure the display effect.

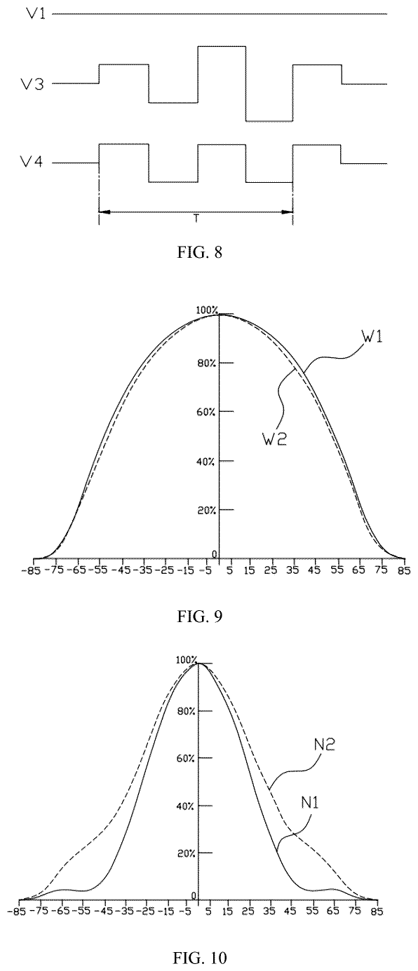

FIG. 7 is a diagram of the signal waveform of the display panel in the wide viewing angle mode according to the first embodiment of the present application; FIG. 8 is a diagram of the signal waveform of the display panel in the narrow viewing angle mode according to the first embodiment of the present application.

The present application further provides a driving method for switching between wide and narrow viewing angles, and the driving method is used to drive the display panel having switchable wide and narrow viewing angles as described above. The driving method includes:

In the wide viewing angle mode, a first electrical signal V1 is applied to the common viewing angle electrode 111, wherein the first electrical signal V1 is a DC common voltage signal, and a second electrical signal V2 is applied to both the first viewing angle electrode 121 and the second viewing angle electrode 122, and the voltage difference between the second electrical signal V2 and the first electrical signal V1 is less than a first preset value (for example, less than 0.7V). Preferably, as shown in FIG. 7, the common viewing angle electrode 111, the first viewing angle electrode 121 and the second viewing angle electrode 122 are all applied with 0V DC voltage. There is basically no vertical electric field formed between the common viewing angle electrode 111 and the first viewing angle electrode 121, as well as between the common viewing angle electrode 111 and the second viewing angle electrode 122. The positive liquid crystal molecules in the first liquid crystal layer 13 basically will not deflect and remain in the initial lying state (FIG. 1). At this time, the light adjusting box 10 is in the wide viewing angle mode. Optionally, the voltage difference between the second electrical signal V2 and the first electrical signal V1 can also be greater than a second preset value (for example, greater than 5.0V), wherein the second preset value is far greater than the first preset value, so that a strong vertical electric field (E2 in FIG. 2) will be formed between the common viewing angle electrode 111 and the first viewing angle electrode 121, as well as between the common viewing angle electrode 111 and the second viewing angle electrode 122, and the positive liquid crystal molecules in the first liquid crystal layer 13 deflect significantly to be perpendicular to the first substrate 11 and the second substrate 12. At this time, the light adjusting box 10 will also be in the wide viewing angle mode.

Since the first viewing angle electrode 121 and the second viewing angle electrode 122 are applied with the same electrical signal in the wide viewing angle mode, the transmittance of the first graphic region 110 and the second graphic region 120 is the same from the front viewing angle or from the same side viewing angle, and the first graphic region 110 and the second graphic region 120 are both in the wide viewing angle mode.

Furthermore, in the wide viewing angle mode, as shown in FIG. 1, in one embodiment, the common viewing angle electrode 111, the first viewing angle electrode 121 and the second viewing angle electrode 122 are all applied with 0V DC voltage, that is, the first electrical signal V1 and the second electrical signal V2 are both 0V DC voltage. As shown in FIG. 2, in another embodiment, the first electrical signal V1 is 0V DC voltage, while the second electrical signal V2 is an AC voltage with an amplitude greater than 5V. As shown in FIG. 9, the curve W1 represents the curve of the transmittance of the first graphic region 110 at different viewing angles, and the curve W2 represents the curve of the transmittance of the second graphic region 120 at different viewing angles. From FIG. 9, it can be seen that in the wide viewing angle mode, the transmittance of the first graphic region 110 and the second graphic region 120 is basically the same at the same viewing angle. The first graphic region 110 and the second graphic region 120 almost have no influence on the display effect under the wide viewing angle mode.

As shown in FIG. 8, in the narrow viewing angle mode, a first electrical signal V1, i.e., a DC common voltage signal, is applied to the common viewing angle electrode 111, a third electrical signal V3 is applied to the first viewing angle electrode 121, and a fourth electrical signal V4 is applied to the second viewing angle electrode 122. The voltage difference between the third electrical signal V3 and the first electrical signal V1, as well as the voltage difference between the fourth electrical signal V4 and the first electrical signal V1, are both greater than a third preset value (for example, greater than 1.2V) and less than a fourth preset value (for example, less than 4.0V), wherein the first preset value is less than or equal to the third preset value, and the second preset value is greater than the fourth preset value. At this time, a relatively strong vertical electric field (E3 and E4 in FIG. 3) will be formed between the common viewing angle electrode 111 and the first viewing angle electrode 121, as well as between the common viewing angle electrode 111 and the second viewing angle electrode 122. The positive liquid crystal molecules in the first liquid crystal layer 13 deflect significantly to be tilted, and the brightness when seeing from large viewing angle is decreased. At this time, the light adjusting box 10 is in the narrow viewing angle mode.

As shown in FIG. 8, at least some of the time within a period T, the amplitude of the third electrical signal V3 is different from the amplitude of the fourth electrical signal V4, and the amplitude of the third electrical signal V3 periodically changes. In this embodiment, within a period T, the amplitude of the third electrical signal V3 during the former T/2 time is the same as the amplitude of the fourth electrical signal V4, while the amplitude of the third electrical signal V3 during the later T/2 time is different from the amplitude of the fourth electrical signal V4.

In the narrow viewing angle mode, at least some of the time within a period T, the amplitude of the third electrical signal V3 is different from the amplitude of the fourth electrical signal V4, and the amplitude of the third electrical signal V3 periodically changes. During the former T/2 time, the amplitude of the third electrical signal V3 is the same as the amplitude of the fourth electrical signal V4, and the brightness/darkness of the first graphic region 110 and the second graphic region 120 is the same from the same side viewing angle. During the later T/2 time, the amplitude of the third electrical signal V3 is different from the amplitude of the fourth electrical signal V4, the positive liquid crystal molecules in the first liquid crystal layer 13 corresponding to the first graphic region 110 and the second graphic region 120 will deflect with different angles, the transmittance of the first graphic region 110 and the second graphic region 120 from the same side viewing angle is accordingly different, and the brightness/darkness of the first graphic region 110 and the second graphic region 120 is also different from the same side viewing angle. Moreover, the amplitude of the third electrical signal V3 periodically changes, such that in the narrow viewing angle mode, when seeing from large viewing angle, the brightness of the first graphic region 110 will flicker periodically, which will affect seeing the displayed picture from large viewing angle. Thus, even in the case of grayscale reversal, the displayed picture on the display panel cannot be seen, thereby increasing the anti-peeping effect at large viewing angle.

As shown in FIG. 10, when the amplitude of the third electrical signal V3 is different from the amplitude of the fourth electrical signal V4, the curve N1 represents the curve of the transmittance of the first graphic region 110 at different viewing angles, and the curve N2 represents the curve of the transmittance of the second graphic region 120 at different viewing angles. From FIG. 10, it can be seen that in the narrow viewing angle mode, when the amplitude of the third electrical signal V3 is different from the amplitude of the fourth electrical signal V4, the transmittance of the first graphic region 110 and the second graphic region 120 is basically the same from the front viewing angle (from −30° to) 30°, while the transmittance is significantly different from large viewing angle (from −55° to −75° and from 55° to) 75°. It can be understood that when the amplitude of the third electrical signal V3 is the same as the amplitude of the fourth electrical signal V4, the transmittance of the first graphic region 110 and the second graphic region 120 is the same under the same viewing angle. Therefore, through the periodic change of the amplitude of the third electrical signal V3, the brightness of the first graphic region 110 flickers periodically in the narrow viewing angle mode when seeing from large viewing angle, thereby affecting seeing the displayed picture from large viewing angle. Thus, even in the case of grayscale reversal, the displayed picture on the display panel cannot be seen, thereby increasing the anti-peeping effect at large viewing angle.

Furthermore, in the narrow viewing angle mode, in one embodiment, the amplitudes of the third electrical signal V3 and the fourth electrical signal V4 are each 1.6V-2.4V, and both the third electrical signal V3 and the fourth electrical signal V4 are an AC voltage. When the amplitude of the third electrical signal V3 is different from the amplitude of the fourth electrical signal V4, the amplitude difference between the third electrical signal V3 and the fourth electrical signal V4 is 0.2V-0.6V, for example, if the amplitude of the fourth electrical signal V4 is 1.6V, the amplitude of the third electrical signal V3 may be varied periodically between 2.0V and 1.6V.

Liquid crystal molecules are prone to polarization under the action of a single direction electric field for a long time. In the narrow viewing angle mode, both the third electric signal V3 and the fourth electric signal V4 adopt AC voltage, such that the direction of the electric field is not a single direction, but is changed continuously, thereby preventing the liquid crystal molecules from polarization under the strong vertical electric field.

In this embodiment, the polarity of the third electrical signal V3 is the same as the polarity of the fourth electrical signal V4 at the same time. Optionally, in other embodiments, the polarity of the third electrical signal V3 can also be opposite to the polarity of the fourth electrical signal V4 at the same time, and accordingly, the direction of the electric field formed between the first viewing angle electrode 121/the second viewing angle electrode 122 and the common viewing angle electrode 111 is also opposite, which will weaken the strength of the vertical electric field at the junction of the first viewing angle electrode 121 and the second viewing angle electrode 122, thereby affecting the effect in the narrow viewing angle mode.

Specifically, the period T of amplitude change of the third electrical signal V3 can be set according to actual situation, and the period T can be different or the same as the period of polarity change of the third electrical signal V3.

### Second Embodiment

FIG. 14 is a diagram of the signal waveform of the display panel in the second embodiment of the present application in the narrow viewing angle mode. As shown in FIG. 14, the display panel, the driving method and the display device provided in the second embodiment of the present application are basically the same as those in the first embodiment (FIGS. 1 to 13), except for the driving method. In this embodiment, in the narrow viewing angle mode, the amplitude of the third electrical signal V3 is different from the amplitude of the fourth electrical signal V4 all the time within a period T, and the amplitude of the fourth electrical signal V4 periodically changes. That is, in the narrow viewing angle mode, when seeing from side viewing angle, the brightness of the second graphic region 120 will also flicker periodically.

Preferably, within a period T, the amplitude of the third electrical signal V3 during the former T/2 time is less than the amplitude of the fourth electrical signal V4, while the amplitude of the third electrical signal V3 during the later T/2 time is greater than the amplitude of the fourth electrical signal V4. Thus, in the narrow viewing angle mode and seeing from large viewing angle, when the first graphic region 110 becomes bright, the second graphic region 120 becomes dark, and when the first graphic region 110 becomes dark, the second graphic region 120 becomes bright. As a result, the brightness difference between the first graphic region 110 and the second graphic region 120 is increased, which is more useful to affect seeing the displayed picture from large viewing angle. Thus, even in the case of grayscale reversal, the displayed picture on the display panel cannot be seen, thereby further increasing the anti-peeping effect at large viewing angle.

It is understood by the persons skilled in the art that the remaining structures and working principles of this embodiment are the same as those of the first embodiment, and are not repeated here.

### Third Embodiment

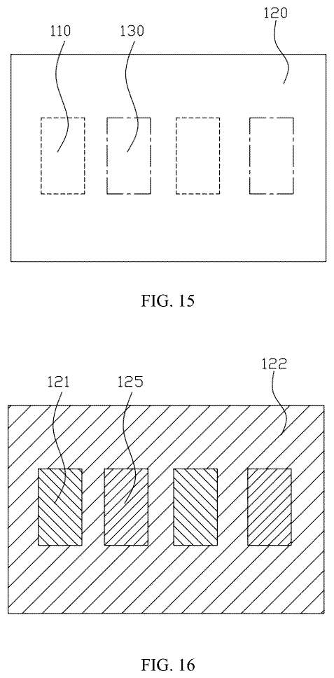

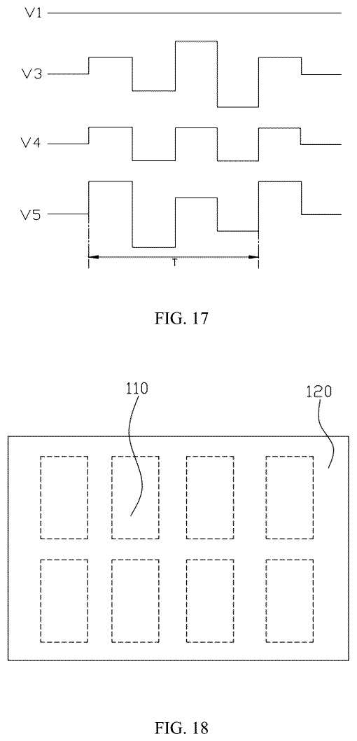

FIG. 15 is a schematic diagram of the planar structure of the display panel in the third embodiment of the present application. FIG. 16 is a schematic diagram of the planar structure of the first viewing angle electrode, the second viewing angle electrode and the third viewing angle electrode in the third embodiment of the present application. FIG. 17 is a diagram of the signal waveform of the display panel in the third embodiment of the present application in the narrow viewing angle mode. As shown in FIGS. 15 to 17, the display panel, the driving method and the display device provided in the third embodiment of the present application are basically the same as those in the first embodiment (FIGS. 1 to 13), except that in this embodiment, the display panel further has a third graphic region 130. A third viewing angle electrode 125 cooperating with the common viewing angle electrode 111 is provided on the side of the second substrate 12 facing the first liquid crystal layer 13, and the third viewing angle electrode 125 corresponds to the third graphic region 130. The first viewing angle electrode 121, the second viewing angle electrode 122 and the third viewing angle electrode 125 are mutually insulated from each other.

Furthermore, the first graphic region 110, the third graphic region 130, the first viewing angle electrode 121 and the third viewing angle electrode 125 are all block structures. The first graphic region 110 and the third graphic region 130 are arranged alternately along the row/column direction, and the second graphic region 120 surrounds the periphery of the first graphic region 110 and the third graphic region 130. The first viewing angle electrode 121 and the third viewing angle electrode 125 are arranged alternately along the row/column direction, and the second viewing angle electrode 122 surrounds the periphery of the first viewing angle electrode 121 and the third viewing angle electrode 125.

In this embodiment, the multiple block structures of the first and third graphic regions 110, 130 are arranged alternately along the row direction, and the multiple block structures of the first and third viewing angle electrodes 121, 125 are arranged alternately along the row direction. Optionally, the multiple block structures of the first and third graphic regions 110, 130 can also be arranged alternately along the column direction, and the multiple block structures of the first and third viewing angle electrodes 121, 125 can also be arranged alternately along the column direction. Alternatively, the first and third graphic regions 110, 130 can be arranged alternately along both row and column directions, and the first and third viewing angle electrodes 121, 125 can be arranged alternately along both row and column directions, so that the first and third graphic regions 110, 130 are distributed in a mosaic-like manner. In the narrow viewing angle mode, when seeing from large viewing angle, the brightness of the first and third graphic regions 110, 130 flickers periodically, which can better affect seeing the displayed picture from large viewing angle, thereby increasing the anti-peeping effect at large viewing angle.

Furthermore, due to the presence of the third viewing angle electrode 125 on the side of the second substrate 12 facing the first liquid crystal layer 13, in order to apply a voltage signal to the third viewing angle electrode 125, the electrode network 123 further includes a third electrode network. The first electrode network 123a, the second electrode network 123b and the third electrode network are insulated and separated from each other, and the third electrode network is electrically connected to the third viewing angle electrode 125. Preferably, the third viewing angle electrode 125 and the first viewing angle electrode 121 are located on the same layer.

As shown in FIG. 17, this embodiment further provides a driving method for switching between wide and narrow viewing angles. The driving method is basically the same as the first embodiment (FIGS. 7 and 8), with the difference being described below.

In the wide viewing angle mode, a first electrical signal V1 is applied to the common viewing angle electrode 111, wherein the first electrical signal V1 is a DC common voltage signal, and a second electrical signal V2 is applied to each of the first viewing angle electrode 121, the second viewing angle electrode 122 and the third viewing angle electrode 125, and the voltage difference between the second electrical signal V2 and the first electrical signal V1 is less than a first preset value (for example, less than 0.7V). Preferably, as shown in FIG. 7, the common viewing angle electrode 111, the first viewing angle electrode 121, the second viewing angle electrode 122 and the third viewing angle electrode 125 are all applied with 0V DC voltage. There is basically no vertical electric field formed between the common viewing angle electrode 111 and the first viewing angle electrode 121, between the common viewing angle electrode 111 and the second viewing angle electrode 122, as well as between the common viewing angle electrode 111 and the third viewing angle electrode 125. The positive liquid crystal molecules in the first liquid crystal layer 13 basically will not deflect and remain in the initial lying state (FIG. 1). At this time, the light adjusting box 10 is in the wide viewing angle mode. Optionally, the voltage difference between the second electrical signal V2 and the first electrical signal V1 can also be greater than a second preset value (for example, greater than 5.0V), wherein the second preset value is far greater than the first preset value, so that a strong vertical electric field (E2 in FIG. 2) will be formed between the common viewing angle electrode 111 and the first viewing angle electrode 121, between the common viewing angle electrode 111 and the second viewing angle electrode 122, as well as between the common viewing angle electrode 111 and the third viewing angle electrode 125, and the positive liquid crystal molecules in the first liquid crystal layer 13 deflect significantly to be perpendicular to the first substrate 11 and the second substrate 12. At this time, the light adjusting box 10 will also be in the wide viewing angle mode.

As shown in FIG. 17, in the narrow viewing angle mode, a first electrical signal V1, i.e., a DC common voltage signal, is applied to the common viewing angle electrode 111, a third electrical signal V3 is applied to the first viewing angle electrode 121, a fourth electrical signal V4 is applied to the second viewing angle electrode 122, and a fifth electrical signal V5 is applied to the third viewing angle electrode 125. The voltage difference between the third electrical signal V3 and the first electrical signal V1, the voltage difference between the fourth electrical signal V4 and the first electrical signal V1, as well as the voltage difference between the fifth electrical signal V5 and the first electrical signal V1, are all greater than a third preset value (for example, greater than 1.2V) and less than a fourth preset value (for example, less than 4.0V), wherein the first preset value is less than or equal to the third preset value, and the second preset value is greater than the fourth preset value. At this time, a relatively strong vertical electric field will be formed between the common viewing angle electrode 111 and the first viewing angle electrode 121, between the common viewing angle electrode 111 and the second viewing angle electrode 122, as well as between the common viewing angle electrode 111 and the third viewing angle electrode 125. The positive liquid crystal molecules in the first liquid crystal layer 13 deflect significantly to be tilted, and the brightness when seeing from large viewing angle is decreased. At this time, the light adjusting box 10 is in the narrow viewing angle mode.

As shown in FIG. 8, at least some of the time within a period T, the amplitude of the third electrical signal V3 is different from the amplitude of the fourth electrical signal V4, and the amplitude of the third electrical signal V3 periodically changes. Further, the amplitude of the fifth electrical signal V5 is different from the amplitude of the third electrical signal V3 all the time, and the amplitude of the fifth electrical signal V5 periodically changes. In this embodiment, within a period T, the amplitude of the third electrical signal V3 during the former T/2 time is the same as the amplitude of the fourth electrical signal V4, the amplitude of the fifth electrical signal V5 during the former T/2 time is different from the amplitude of the fourth electrical signal V4, the amplitude of the third electrical signal V3 during the later T/2 time is different from the amplitude of the fourth electrical signal V4, and the amplitude of the fifth electrical signal V5 during the later T/2 time is the same as the amplitude of the fourth electrical signal V4. Thus, in the narrow viewing angle mode and seeing from large viewing angle, when the first graphic region 110 becomes bright, the third graphic region 130 becomes dark, and when the first graphic region 110 becomes dark, the third graphic region 130 becomes bright. As a result, the brightness difference between the first graphic region 110 and the third graphic region 130 is increased, which is more useful to affect seeing the displayed picture from large viewing angle. Thus, even in the case of grayscale reversal, the displayed picture on the display panel cannot be seen, thereby further increasing the anti-peeping effect at large viewing angle.

Specifically, the third electrical signal V3 can be an AC signal with constant amplitude as shown in FIG. 8, or it can also be an AC signal with amplitude changing periodically as shown in FIG. 14. The amplitude of the third electrical signal V3 and the amplitude of the fifth electrical signal V5 are preferably different at the same time, so that when seeing from large viewing angle in the narrow viewing angle mode, the first graphic region 110, the second graphic region 120 and the third graphic region 130 all flicker periodically with different brightness, which will affect seeing the displayed picture from large viewing angle. Optionally, the amplitude of the third electrical signal V3 can be the same as the amplitude of the fifth electrical signal V5.

Furthermore, the fifth electrical signal V5 is an AC voltage with an amplitude between 1.6V-2.4V. When the amplitude of the fifth electrical signal V5 is different from the amplitude of the third electrical signal V3, the amplitude difference between the fifth electrical signal V5 and the fourth electrical signal V4 is 0.2V-0.6V.

It is understood by the persons skilled in the art that the remaining structures and working principles of this embodiment are the same as those of the first embodiment, and are not repeated here.

### Fourth Embodiment

FIG. 18 is a schematic diagram of the planar structure of the display panel in the fourth embodiment of the present application. FIG. 19 is a schematic diagram of the planar structure of the first viewing angle electrode and the second viewing angle electrode in the fourth embodiment of the present application. As shown in FIGS. 18 and 19, the display panel, the driving method and the display device provided in the fourth embodiment of the present application are basically the same as those in the first embodiment (FIGS. 1 to 13), except for the structure of the display panel. In this embodiment, both the first graphic region 110 and the first viewing angle electrode 121 have multiple rows/columns, that is, multiple block structures of the first graphic region 110 and the first viewing angle electrode 121 are arranged in a matrix.

Thus, the distribution of the first graphic regions 110 on the display panel is more uniform. In the narrow viewing angle mode, when seeing from large viewing angle, the brightness of the first graphic region 110 flickers periodically, which can better affect seeing the displayed picture from large viewing angle and increase the anti-peeping effect at large viewing angle.

It is understood by the persons skilled in the art that the remaining structures and working principles of this embodiment are the same as those of the first embodiment, and are not repeated here.

### Fifth Embodiment

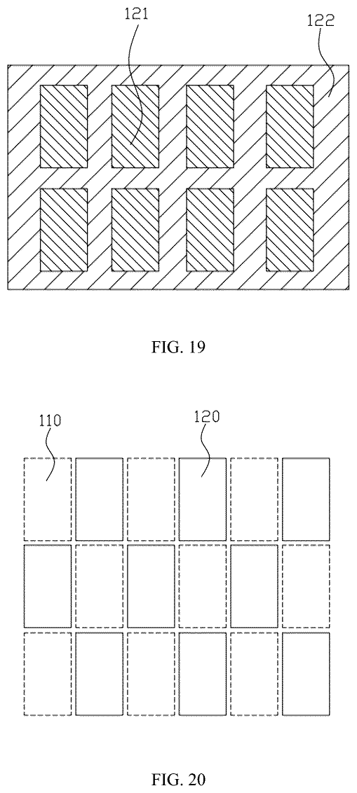

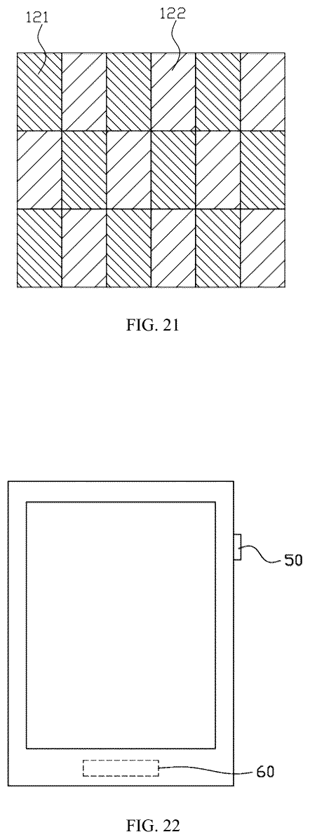

FIG. 20 is a schematic diagram of the planar structure of the display panel in the fifth embodiment of the present application. FIG. 21 is a schematic diagram of the planar structure of the first viewing angle electrode and the second viewing angle electrode in the fifth embodiment of the present application. As shown in FIGS. 20 to 21, the display panel, the driving method and the display device provided in the fifth embodiment of the present application are basically the same as those in the first embodiment (FIGS. 1 to 13), except for the structure of the display panel. In this embodiment, the first graphic region 110, the second graphic region 120, the first viewing angle electrode 121 and the second viewing angle electrode 122 are all block structures, wherein the first graphic region 110 and the second graphic region 120 are arranged alternately in both row and column directions, and the first viewing angle electrode 121 and the second viewing angle electrode 122 are arranged alternately in both row and column directions, so that the first graphic region 110 and the second graphic region 120 are distributed in a mosaic-like pattern. When seeing from large viewing angle in the narrow viewing angle mode, the brightness of the first graphic region 110 and the second graphic region 120 flickers periodically, which can greatly affect seeing the displayed picture from large viewing angle and increase the anti-peeping effect at large viewing angle.

It is understood by the persons skilled in the art that the remaining structures and working principles of this embodiment are the same as those of the first embodiment, and are not repeated here.

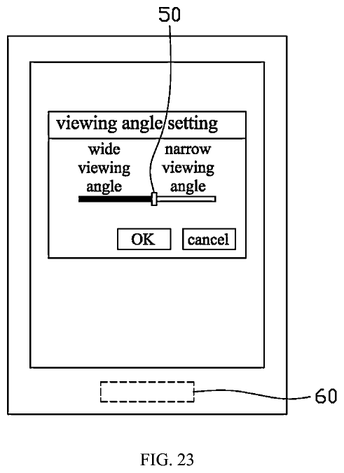

FIG. 22 is a first schematic diagram of the planar structure of the display device in the present application, and FIG. 23 is a second schematic diagram of the planar structure of the display device in the present application. Referring to FIG. 22 and FIG. 23, the display device is provided with a viewing angle switch button 50 for the user to send a viewing angle switch request to the display device. The viewing angle switch button 50 may be a mechanical key (as shown in FIG. 22), or a software control or application program (APP) to realize the switching function (as shown in FIG. 23, for example, the wide and narrow viewing angles can be set through the slider). When the user needs to switch between a wide viewing angle mode and a narrow viewing angle mode, the user can send a request for switching viewing angle to the display device by operating the viewing angle switch button 50. Finally, different electrical signals are applied to the common viewing angle electrode 111, the first viewing angle electrode 121, the second viewing angle electrode 122 and the third viewing angle electrode 125 under control by the driver chip 60, such that the display device can switch between a wide viewing angle mode and a narrow viewing angle mode. When switching to the wide viewing angle mode, the display device adopts the driving method corresponding to the wide viewing angle mode. When switching to the narrow viewing angle mode, the display device adopts the driving method corresponding to the narrow viewing angle mode. Therefore, the display device in the embodiments of the present application has strong operational flexibility and convenience, and achieves a multi-function display device integrating entertainment videos and privacy.

In this description, the terms “up”, “down”, “left”, “right”, “front”, “back”, etc. are defined based on the position of the structure in the attached figures and the position between the structures, and are only for the clarity and convenience to express the technical solution. It should be understood that the use of the directional terms should not limit the scope of protection in this application.

It should also be understood that the terms “first”, “second”, etc. used in this description are only for distinguishing similar elements and are not intended to limit quantity or order.

The above is only preferred embodiments of the present application and does not limit the present application in any form. Although the present application has been disclosed in preferred embodiments, it is not intended to limit the present application. Any person skilled in the art can make some changes or modifications within the scope of the technical solution of the present application using the disclosed technical content. Any simple modifications, equivalent changes, and modifications made to the above embodiments based on the technical solution of the present application without departing from the technical solution of the present application shall still fall within the scope of protection of the technical solution of the present application.

### INDUSTRIAL APPLICABILITY

The display panel has a first graphic region and a second graphic region that are patterned, and the display panel includes a light adjusting box and a display box which are stacked with one on another. The light adjusting box includes a first substrate, a second substrate, and a first liquid crystal layer. The first substrate is provided with a common viewing angle electrode, and the second substrate is provided with a first viewing angle electrode and a second viewing angle electrode that are cooperated with the common viewing angle electrode. The first viewing angle electrode corresponds to the first graphic region, and the second viewing angle electrode corresponds to the second graphic region. In the narrow viewing angle mode, a first electrical signal is applied to the common viewing angle electrode, a third electrical signal is applied to the first viewing angle electrode, and a fourth electrical signal is applied to the second viewing angle electrode. The amplitude of the third electrical signal is different from the amplitude of the fourth electrical signal for at least part of the time within one period, and the amplitude of the third electrical signal periodically changes, such that the transmittance of the first graphic region from the same side viewing angle also periodically changes. That is, when seeing from large viewing angle, the brightness of the first graphic region will flicker, thereby affecting seeing the displayed picture from large viewing angle. Thus, even in the case of grayscale reversal, the displayed picture on the display panel cannot be seen, thereby increasing the anti-peeping effect at large viewing angle.

1. A driving method for a display panel with switchable wide and narrow viewing angles, wherein the display panel has a first graphic region and a second graphic region, and the display panel comprises a light adjusting box and a display box which are stacked with one on another;
the light adjusting box comprises a first substrate, a second substrate opposite to the first substrate, and a first liquid crystal layer between the first substrate and the second substrate, the first substrate is provided with a common viewing angle electrode on the side facing the first liquid crystal layer, the second substrate is provided with a first viewing angle electrode and a second viewing angle electrode which are cooperated with the common viewing angle electrode on the side facing the first liquid crystal layer, the first viewing angle electrode and the second viewing angle electrode are insulated and separated from each other, the first viewing angle electrode corresponds to the first graphic region, the second viewing angle electrode corresponds to the second graphic region;
the driving method comprises:
in the wide viewing angle mode, a first electrical signal is applied to the common viewing angle electrode, and a second electrical signal is applied to both the first viewing angle electrode and the second viewing angle electrode, the voltage difference between the second electrical signal and the first electrical signal is less than a first preset value or greater than a second preset value, the transmittance of the first graphic region and the second graphic region is the same from the same side viewing angle;
in the narrow viewing angle mode, a first electrical signal is applied to the common viewing angle electrode, a third electrical signal is applied to the first viewing angle electrode, and a fourth electrical signal is applied to the second viewing angle electrode, the voltage difference between the third electrical signal and the first electrical signal, as well as the voltage difference between the fourth electrical signal and the first electrical signal, are both greater than a third preset value and less than a fourth preset value, wherein the amplitude of the third electrical signal is different from the amplitude of the fourth electrical signal for at least part of the time within one period, and the amplitude of the third electrical signal periodically changes, such that the transmittance of the first graphic region from the same side viewing angle periodically changes;
wherein the first preset value is less than or equal to the third preset value, and the second preset value is greater than the fourth preset value.

2. The driving method as claimed in claim 1, wherein the amplitude of the third electrical signal is different from the amplitude of the fourth electrical signal all the time within the period, and the amplitude of the fourth electrical signal periodically changes.

3. The driving method as claimed in claim 1, wherein both the first electrical signal and the second electrical signal are 0V DC voltage; or the first electrical signal is 0V DC voltage, and the second electrical signal is an AC voltage with an amplitude greater than 5V.

4. The driving method as claimed in claim 1, wherein the amplitudes of the third electrical signal and the fourth electrical signal are each 1.6V-2.4V, and both the third electrical signal and the fourth electrical signal are AC voltage.

5. The driving method as claimed in claim 1, wherein when the amplitude of the third electrical signal is different from the amplitude of the fourth electrical signal, the amplitude difference between the third electrical signal and the fourth electrical signal is 0.2V-0.6V.

6. The driving method as claimed in claim 1, wherein the polarity of the third electrical signal is the same as the polarity of the fourth electrical signal at the same time.

7. The driving method as claimed in claim 1, wherein the display panel has a third graphic region, the second substrate is provided with a third viewing angle electrode cooperating with the common viewing angle electrode on the side facing the first liquid crystal layer, the third viewing angle electrode corresponds to the third graphic region, and the first viewing angle electrode, the second viewing angle electrode and the third viewing angle electrode are mutually insulated from each other;
the driving method further comprises:
in the wide viewing angle mode, the second electrical signal is applied to the third viewing angle electrode;
in the narrow viewing angle mode, a fifth electrical signal is applied to the third viewing angle electrode, the voltage difference between the fifth electrical signal and the first electrical signal is greater than the third preset value and less than the fourth preset value, wherein the amplitude of the fifth electrical signal is different from the amplitude of the third electrical signal all the time within the period, and the amplitude of the fifth electrical signal periodically changes.

8. The driving method as claimed in claim 7, wherein the fifth electrical signal is an AC voltage with an amplitude between 1.6V-2.4V, when the amplitude of the fifth electrical signal is different from the amplitude of the third electrical signal, the amplitude difference between the fifth electrical signal and the third electrical signal is 0.2V-0.6V.

9. A display panel with switchable wide and narrow viewing angles, wherein the display panel is driven using the driving method as claimed in claim 1, the display panel has a first graphic region and a second graphic region, and the display panel comprises a light adjusting box and a display box which are stacked with one on another;
the light adjusting box comprises a first substrate, a second substrate opposite to the first substrate, and a first liquid crystal layer between the first substrate and the second substrate, the first substrate is provided with a common viewing angle electrode on the side facing the first liquid crystal layer, the second substrate is provided with a first viewing angle electrode and a second viewing angle electrode which are cooperated with the common viewing angle electrode on the side facing the first liquid crystal layer, the first viewing angle electrode and the second viewing angle electrode are insulated and separated from each other, the first viewing angle electrode corresponds to the first graphic region, the second viewing angle electrode corresponds to the second graphic region.

10. The display panel as claimed in claim 9, wherein both the first graphic region and the first viewing angle electrode are multiple block structures arranged along the row/column direction and spaced from each other, the second graphic region surrounds the periphery of the first graphic region, and the second viewing angle electrode surrounds the periphery of the first viewing angle electrode.

11. The display panel as claimed in claim 10, wherein both the first graphic region and the first viewing angle electrode have multiple rows/columns.

12. The display panel as claimed in claim 9, wherein the first graphic region, the second graphic region, the first viewing angle electrode and the second viewing angle electrode are all block structures, wherein the first graphic region and the second graphic region are arranged alternately in both row and column directions, and the first viewing angle electrode and the second viewing angle electrode are arranged alternately in both row and column directions.

13. The display panel as claimed in claim 9, wherein the display panel has a third graphic region, the second substrate is provided with a third viewing angle electrode cooperating with the common viewing angle electrode on the side facing the first liquid crystal layer, the third viewing angle electrode corresponds to the third graphic region, and the first viewing angle electrode, the second viewing angle electrode and the third viewing angle electrode are mutually insulated from each other.

14. The display panel as claimed in claim 13, wherein the first graphic region, the third graphic region, the first viewing angle electrode and the third viewing angle electrode are all block structures, wherein the first graphic region and the third graphic region are arranged alternately along the row/column direction, the second graphic region surrounds the periphery of the first graphic region and the third graphic region, the first viewing angle electrode and the third viewing angle electrode are arranged alternately along the row/column direction, and the second viewing angle electrode surrounds the periphery of the first viewing angle electrode and the third viewing angle electrode.

15. The display panel as claimed in claim 14, wherein the first graphic region and the third graphic region are arranged alternately in both row and column directions, and the first viewing angle electrode and the third viewing angle electrode are arranged alternately in both row and column directions.

16. The display panel as claimed in claim 9, wherein the second substrate is provided with an electrode network on the side facing the first liquid crystal layer, the electrode network comprises a first electrode network and a second electrode network which are mutually insulated and separated from each other, the first viewing angle electrode is electrically connected to the first electrode network, and the second viewing angle electrode is electrically connected to the second electrode network.

17. A display device comprising the display panel as claimed in claim 9.
